(19) United States
(12) Patent Application Publication
(10) Pub. No.: US 2024/0015341 A1
(43) Pub. Date: Jan. 11, 2024

(54) Method and Apparatus for Interactive Live Streaming Events

(71) Applicant: InLive, Inc., Palto Alto, CA (US)

(72) Inventors: Pravin Kumar, Palo Alto, CA (US); Calvin Lui, San Francisco, CA (US)

(21) Appl. No.: 18/220,523

(22) Filed: Jul. 11, 2023

Related U.S. Application Data
(60) Provisional application No. 63/368,120, filed on Jul. 11, 2022.

(51) Int. Cl. H04N 21/2187; H04N 21/258; H04N 21/475; H04N 21/4788

(52) U.S. Cl. CPC H04N 21/2187; H04N 21/25891; H04N 21/4758; H04N 21/4788

(57) ABSTRACT

A video streaming service provides an auxiliary content database serving additional content composited with the video stream upon detection of a time occurrence, the presence of a particular image, or a particular audio cue, the additional content providing additional information relevant to the current streamed video. A user profile allows filtration of auxiliary content according to user preferences.

### CROSS REFERENCE TO RELATED APPLICATION

This application claims the benefit of U.S. provisional application 63/368,120 filed Jul. 11, 2022 and hereby incorporated by reference

### STATEMENT REGARDING FEDERALLY SPONSORED RESEARCH OR DEVELOPMENT

[symbol]

### BACKGROUND OF THE INVENTION

The present invention relates generally interactive video and in particular to an improved interactive video system for live streams.

As streaming becomes more mainstream, stream producers want to interact with consumers during the streaming process. This can be done on a separate webpage that is not connected to the video, for example, displayed on the user's smart phone or tablet, but is done at the expense of requiring additional equipment and effort by the consumer to set up the necessary connections.

Alternatively, a separate data stream can be sent with the video signal to provide displays directly on the video device, for example, triggered by pausing the video as is done with the Amazon x-ray service.

### SUMMARY OF THE INVENTION

The present invention provides an improved interactive system for live streaming that communicates with the user during the streaming process through the use of a translucent window providing ancillary data and serving as an interface for input by the viewer. The data may be triggered by timestamps (for pre-recorded material) or real-time image recognition or audio recognition (for live streaming) to provide flexible interaction in real time. Importantly, the triggers are moderated by a user profile that can be manually populated by the user or developed by monitoring the user's interaction with the interactive system and serves to minimize unwanted distractions from this ancillary data while ensuring that desired ancillary data is promptly presented.

These particular objects and advantages may apply to only some embodiments falling within the claims and thus do not define the scope of the invention.

### BRIEF DESCRIPTION OF THE DRAWINGS

FIG. 1 is a simplified block diagram of the interactive video streaming system providing a video channel and a side channel to a consumer video device and showing a cue generator suitable for use with streaming events;

FIG. 2 is a detail block diagram of the cue generator of FIG. 1 showing separate treatment of the logical channels of a video timecode, video, and audio for the generation of cues according to a cue database;

FIG. 3 is an example video overlay anchored on the screen to a point of reference identified by the present invention; and

FIG. 4 is a simplified block diagram of a pass-through system for connecting the user with a variety of different interactive services using the present invention.

### DETAILED DESCRIPTION OF THE PREFERRED EMBODIMENT

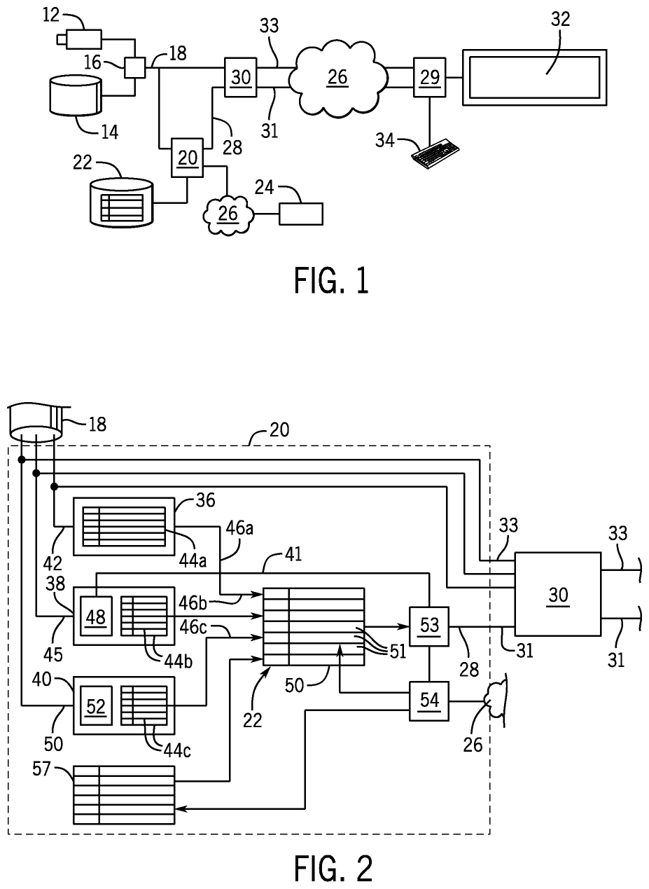

Referring now to FIG. 1, an interactive streaming system 10 may provide for a live-stream source 12, such as one or more cameras, microphones, and the like, for streaming a live event and may also provide a pre-recorded source 14 which may be used together with the live-stream source 12 or individually as switched by a stream switch 16 to provide a mixed stream signal 18 consisting of pre-recorded and live content.

The mixed stream signal 18 may be provided to a cue generator 20 having access to database content 22 and interactive services 24, for example, accessible over the Internet 26 as will be discussed in more detail below.

The cue generator 20 produces auxiliary data 28 that may be received together with the mixed stream signal 18 by a video server 30 for transmission over the Internet using a first one-way streaming video channel 33 and a second bidirectional side channel 31, both communicated via Internet packets with a streaming device 29, for example, of the type manufactured by Roku or Amazon, providing an Internet interface for video signals. The streaming device 29 will be capable of compositing the mixed stream signal 18 and auxiliary data 28 as will be discussed below to provide a unified output on a television-type display 32, including information from both the mixed stream signal 18 and auxiliary data 28. The streaming device 29 will also provide the ability to receive inputs from the user device 34 such as from a remote control, keyboard, voice assistant, or the like, for communication back on the side channel 31. These return communications will be received by the video server 30 to be relayed to the cue generator 20 for interaction with the consumer as will be discussed below.

Referring to FIG. 2, the cue generator 20 may provide a time trigger 36, an image trigger 38, and an audio clip trigger 40. The time trigger 36 may receive timecode channel information 42 related to a real time clock or an encoded time signal in the prerecorded source 14 and match the timecode to predetermined times in a cue list 44a linking timecodes to a particular cue 46a as will be discussed below. Similarly, the image trigger 38 may receive the video channel signal 45 of the mixed stream signal 18 and provides this information to a machine learning image classifier 48, for example, identifying objects or people in the video according to a training set for such objects or people. The machine learning image classifier 48 may communicate with a cue list 44 linking particular classifications (e.g., particular people) appearing in the video channel signal 45 to cues 46. The machine learning image classifier 48 may also produce a location signal 41 identifying a location within the video frame of the video channel signal 45 where the identified object or person appears. Finally, the audio clip trigger 40 may receive the audio channel track 50 from the mixed stream signal 18 and provide that to a machine learning audio classifier 52 to identify audio clips which it is trained to recognize. Such audio cues 46c may, for example, be identifications of songs playing in the background of the video or the like. The audio clips may be further processed by a speech-to-text engine (separate or incorporated into the machine learning audio classifier 52) to identify particular spoken audio content, for example, particular phrases or spoken words. The identification by the machine learning audio classifier 52 is provided to the cue list 44c to generate audio cues 46c.

Each cue 46 may be associated with a duration or the duration may be derived from the persistence of the recognition event.

Each of the cues 46a-46c may be provided to an auxiliary content database 50 linking the cues 46 to auxiliary content 51. The auxiliary content database 50 may further receive subscriber information from subscriber profile table 57. The subscriber profile information may subscriber demographic information, for example, subscriber age and gender, that may be provided by a subscriber when signing up for the stream or collected from a history of subscriber interaction with the interactive streaming system 10, for example related to the subscriber's interaction with auxiliary information presented by the interactive streaming system 10 such as reveals the subscriber's preferences for information from the auxiliary content database 50. Thus, for example, a subscriber showing a general interest in women's hand bags would enroll that preference in the auxiliary content database 52, causing the interactive streaming system 10 to preferentially provide information about women's handbags and possibly other related accessories and clothing. On the other hand, as a subscriber who has repeatedly chosen not to interact with information about women's clothing would be blocked from seeing auxiliary information about women's clothing as that preference is learned by the auxiliary content database 52. In this way, the auxiliary content database 52 may select auxiliary content based not only on the streaming data but on the preferences of the receiving subscriber to eliminate unnecessary clutter and distraction on the screen during streaming. As noted, population of the subscriber profile table 57 may be done by the subscriber, for example, using the keyboard 34 at a configuration time or may be deduced from the subscribers pattern of behavior or other known information about the subscriber.

This ultimately selected auxiliary content 51 is received by a side channel interface 53 which outputs the auxiliary content 51 on the side channel 31. The side channel interface 53 also receives the location signal 41 which may be encoded into the auxiliary data 28 and will be used by the streaming device 29 to locate the auxiliary content 51 of the auxiliary content database 50 in the video frame that will be sent as the auxiliary data 28. A standard location may be designated in the event that the cues 46a or 46c are invoked, and arbitrary locations may also be encoded in those cue lists 44a and 44c as desired.

Referring now to FIG. 3, generally the auxiliary data 28 will provide for a video element 60 having a size less than the screen size or size of the video frame 62 presented on the display 32 which may thus be located at a variety of different locations around the video frame 62. In the event that the cue 46 is generated by image trigger 38, the location signal 41 may be used to anchor the video element 60 to the object 64 being identified, in this case a purse identified by name in the video element 60. A similar approach may be used with actors or other objects within the video frame 62 recognized by the image trigger 38.

The video element 60 is composited to be transparent or translucent so that the underlying video frame 62 may be seen in part. Such translucent effects may be realized, for example, by a weighted averaging of the pixel values of the overlapping signals with added weighting for text and text enhancement features, for example, haloing the text with a contrasting color or value.

In the event that an audio cue 46c is developed by audio clip trigger 40, it may work in conjunction with image trigger 38 to identify a source of that audio element, for example, a musical instrument, person speaking, or the like, so that audio-generated cues 46c may also be attached to particular items.

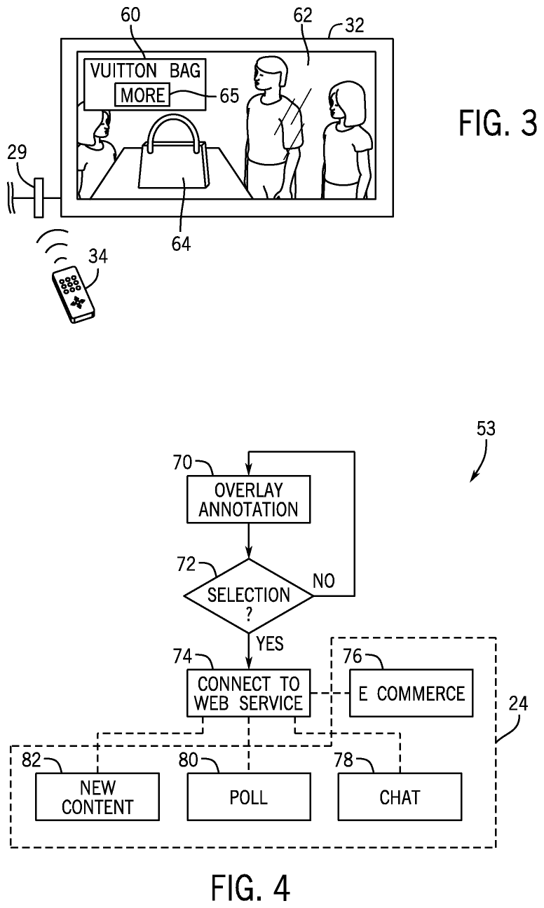

Importantly, the video element also includes a focus panel 65 allowing the user to interact with the video element 60 as an interface, for example, by clicking on the panel 65 to obtain additional data or the like or to indicate a lack of interest in this auxiliary data such as will affect the data in the subscriber profile table 57. Referring to FIG. 4 in this regard a modified Web server 54 (shown in FIG. 2) may monitor any return signal on the side channel 31 as indicated by process block 70 for indication of interaction by the user (pressing on the focus panel 65 for entering text or other data) as indicated by decision block 72. The modified Web server 54 may then generate dynamic additional content in database 50 allowing conventional Web-type interaction between the user and the modified Web server 54 per process block 74. This interaction may be used for a variety of purposes, for example, by the modified Web server connecting the user through the interface of the video element 60 with e-commerce servers 76, chat servers 78, a polling or live auction stream 80, or a commerce system unlocking additional video content 82, for example, in the form of premium content or the like. This mechanism may also be used to alter the video content from the prerecorded source 14, for example, in a choose-you're your-own adventure type situation. Commerce may be handled through normal channels such as credit cards or a stored value handled by the system.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

What we claim is:

1. A live streaming system comprising a set of electronic computers executing a program in stored media to:
(a) serve as a video stream;
(b) detect trigger points in the video stream to composite auxiliary information with the video stream relevant to the video stream at the time of the trigger points;
(c) suppress some trigger points based on preferences by a viewer of the video stream.

2. The live streaming system of claim 1 wherein the trigger points are derived from a time signal embedded in the video stream.

3. The live streaming system of claim 1 wherein the trigger points the trigger points are derived from an image recognized in the video stream.

4. The live streaming system of claim 1 wherein the trigger points the trigger points are derived from an audio signal in the video stream.

5. The live streaming system of claim 1 wherein the composite auxiliary information is provided in a translucent interaction window providing an interface for communication with a viewer of the video stream;
